(19) United States
(12) Patent Application Publication
(10) Pub. No.: US 2015/0205368 A1
(43) Pub. Date: Jul. 23, 2015

(54) DYNAMIC TACTILE INTERFACE

(71) Applicant: Tactus Technology, Inc., Fremont, CA (US)

(72) Inventors: Micah Yairi, Fremont, CA (US); Curtis Ray, Fremont, CA (US); Nate Saal, Fremont, CA (US)

(21) Appl. No.: 14/591,807

(22) Filed: Jan. 7, 2015

Related U.S. Application Data
(60) Provisional application No. 61/924,466, filed on Jan. 7, 2014.

(51) Int. Cl. G06F 3/02; G06F 3/0488; G06F 3/0489; G06F 3/0354

(52) U.S. Cl. CPC G06F 3/0202; G06F 3/03547; G06F 3/04886; G06F 3/04895; G06F 2203/04809

(57) ABSTRACT

A dynamic tactile interface includes a tactile layer including an attachment surface, a peripheral region, and a deformable region adjacent the peripheral region, the deformable region operable between a retracted setting and an expanded setting; a substrate coupled to the attachment surface at the peripheral region and defining a fluid conduit and a fluid channel fluidly coupled to the fluid conduit, the fluid conduit adjacent the deformable region; a first magnet coupled to the substrate proximal the deformable region; and a second magnet coupled to the tactile layer at the deformable region and magnetically coupled to the first magnet, the first magnet and the second magnet cooperating to yield a nonlinear displacement of the deformable region in the expanded setting toward the substrate in response to a force applied to the tactile surface at the deformable region.

### CROSS-REFERENCE TO RELATED APPLICATIONS

This application claims the benefit of U.S. Provisional Application No. 61/924,466, filed 7 Jan. 2014; and U.S. Provisional Application No. 61/924,475, filed 7 Jan. 2014, which are incorporated in their entireties by this reference.

This application is related to U.S. patent application Ser. No. 11/969,848, filed on 4 Jan. 2008; U.S. patent application Ser. No. 13/414,589, filed 7 Mar. 2012; U.S. patent application Ser. No. 13/456,010, filed 25 Apr. 2012; U.S. patent application Ser. No. 13/456,031, filed 25 Apr. 2012; U.S. patent application Ser. No. 13/465,737, filed 7 May 2012; U.S. patent application Ser. No. 13/465,772, filed 7 May 2012; U.S. patent application Ser. No. 14/552,312, filed on 1 Apr. 2014; U.S. patent application Ser. No. 12/830,430, filed 5 Jul. 2010; U.S. patent application Ser. No. 14/081,519, filed on 15 Nov. 2013; U.S. patent application Ser. No. 14/035,851, filed 25 Sep. 2013; U.S. patent application Ser. No. 13/481,676, filed 25 May 2012; U.S. patent application Ser. No. 12/652,708, filed 5 Jan. 2010; and U.S. patent application Ser. No. 14/552,312, filed 25 Nov. 2014, all of which are incorporated in their entireties by this reference.

### TECHNICAL FIELD

This invention relates generally to user interfaces, and more specifically to a new and useful dynamic tactile interface 100 in the field of user interfaces.

### BRIEF DESCRIPTION OF THE FIGURES

FIGS. 1A, 1B, and 1C are schematic representations of a dynamic tactile interface;

FIG. 2 is a flowchart representation of one variation of the dynamic tactile interface.

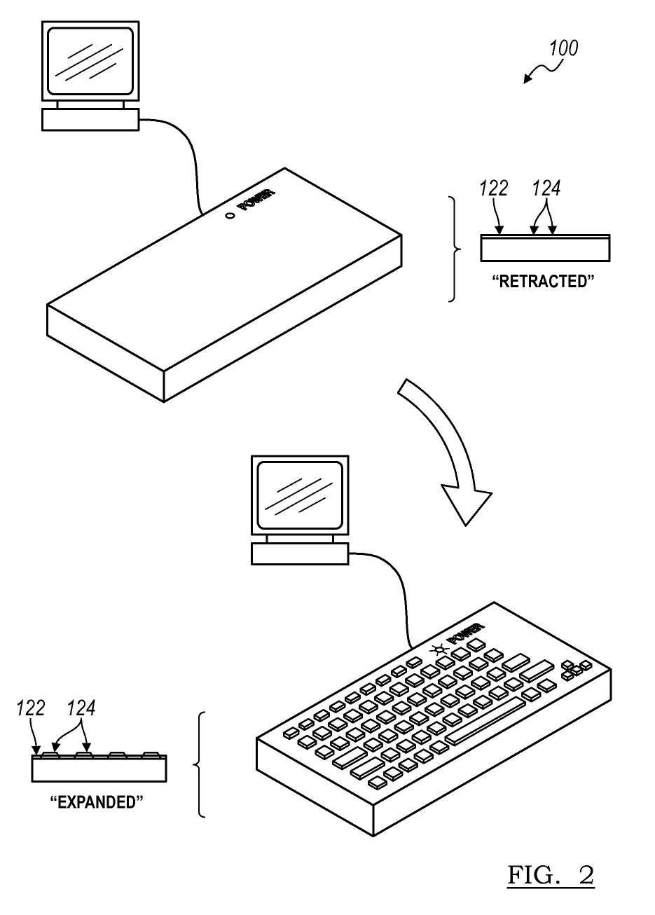

FIG. 3A is a schematic representation of the dynamic tactile interface and FIGS. 3B and 3C are flowchart representations of a dynamic tactile interface;

FIG. 4 is a flowchart representation of one variation of the dynamic tactile interface;

FIG. 5 is a flowchart representation of one variation of the dynamic tactile interface;

FIGS. 6A and 6B are schematic representations of variations of the dynamic tactile interface;

FIG. 7 is a flowchart representation of one variation of the dynamic tactile interface;

FIG. 8 is a flowchart representation of one variation of the dynamic tactile interface;

FIGS. 9A, 9B and 9C are schematic representations of variations of the dynamic tactile interface

### DESCRIPTION OF THE EMBODIMENTS

The following description of embodiments of the invention is not intended to limit the invention to these embodiments, but rather to enable any person skilled in the art to make and use this invention.

### 1. Dynamic Tactile Interface

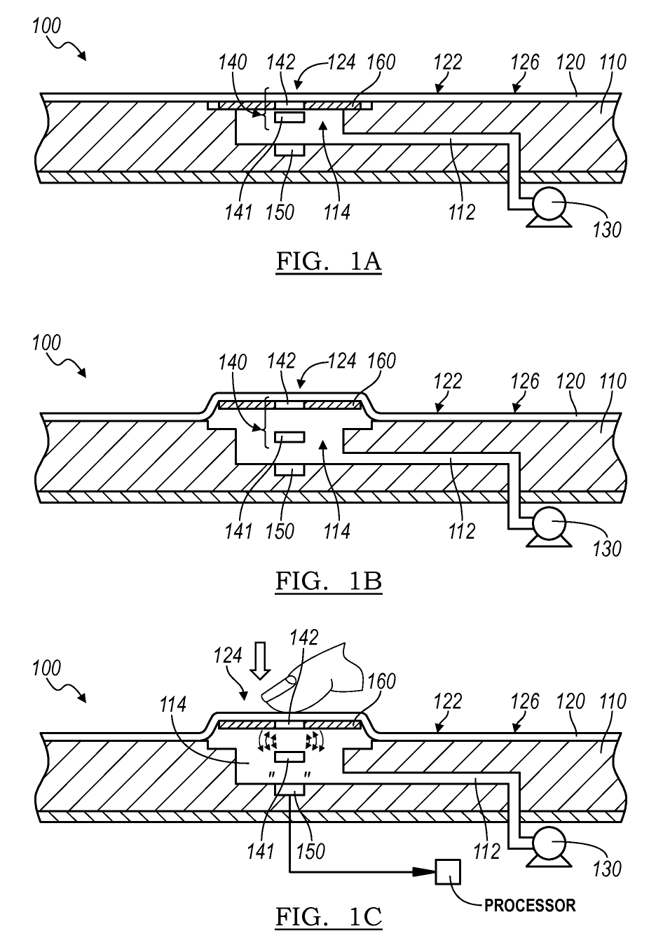

As shown in FIGS. 1A, 1B, and 1C, a dynamic tactile interface 100 includes: a substrate 110 defining a fluid channel 112 and a fluid conduit 114 fluidly coupled to the fluid channel; an elastomer layer including a peripheral region 122 coupled to the substrate 110, a deformable region 124 adjacent the peripheral region 122 and arranged over the fluid conduit, and a tactile surface 126 opposite the substrate 110; a displacement device 130 configured to displace fluid into the fluid channel 112 to transition the deformable region 124 from a retracted setting (shown in FIG. 1A) to an expanded setting (shown in FIG. 1B), the deformable region 124 substantially flush with the peripheral region 122 in the retracted setting and elevated above the peripheral region 122 in the expanded setting; a haptic element 140 coupled to the substrate 110 and configured to yield a nonlinear displacement of the deformable region 124 in the expanded setting toward the substrate 110 in response to application of a force on the deformable region 124 at the tactile surface 126 (shown in FIG. 1C); and a sensor 150 configured to output a signal in response to displacement of the deformable region 124 in the expanded setting toward the substrate 110.

In one variation of the dynamic tactile interface 100, the dynamic tactile interface 100 includes: a tactile layer 120 including an attachment surface, a peripheral region 124, and a deformable region 122 adjacent the peripheral region, the deformable region operable between a retracted setting and an expanded setting, the deformable region in the expanded setting tactilely distinguishable from the peripheral region and the deformable region in the retracted setting; a substrate coupled to the attachment surface at the peripheral region and defining a fluid conduit and a fluid channel fluidly coupled to the fluid conduit, the fluid conduit adjacent the deformable region; a displacement device fluidly coupled to the fluid channel and configured to displace fluid into the fluid conduit to transition the deformable region from the retracted setting to the expanded setting and to displace fluid out of the fluid conduit in response to an input on the deformable region in the expanded setting to transition the deformable region from the expanded setting to the retracted setting; a first magnet coupled to the substrate proximal the deformable region; a second magnet coupled to the tactile layer at the deformable region and magnetically coupled to the first magnet, the first magnet and the second magnet cooperating to yield a nonlinear displacement of the deformable region in the expanded setting toward the substrate in response to a force applied to the tactile surface at the deformable region, the first magnet contacting the second magnet in the retracted setting (e.g., a planar surface of the first magnet or a surface of the first magnet mating with a surface of the second magnet) offset from the second magnet by an attraction distance in the expanded setting; and a sensor outputting a signal in response to displacement of the deformable region toward the substrate.

In another variation, the dynamic tactile interface 100 includes: a tactile layer including an attachment surface, a peripheral region, and a deformable region adjacent the peripheral region, the deformable region operable between a retracted setting and an expanded setting tactilely distinguishable from the peripheral region; a substrate coupled to the attachment surface at the peripheral region and defining a fluid conduit and a fluid channel fluidly coupled to the fluid conduit, the fluid conduit adjacent the deformable region; a displacement device fluidly coupled to the fluid channel and configured to displace fluid into the fluid conduit to transition the deformable region from a retracted setting to an expanded setting; a first electromagnetic element coupled to the substrate proximal the deformable region and outputting a first electromagnetic field; a second electromagnetic element coupled to the tactile layer at the deformable region and outputting a second electromagnetic field, the second electromagnetic element attracted to the first electromagnetic element in a first setting and repelling the first electromagnetic element in a second setting; and a processor electrically coupled to the first electromagnetic element and to the second electromagnetic element, configuring the first electromagnetic element and the second electromagnetic element in the second setting to guide transition of the deformable region from the retracted setting to the expanded setting, and configuring the first electromagnetic element and the second electromagnetic element in the first setting to draw the deformable region toward the substrate in response to an input on the de in the expanded setting.

In another variation, the dynamic tactile interface 100 can include: a tactile layer including a peripheral region and a deformable region adjacent the peripheral region, the deformable region operable between an expanded setting and a retracted setting, the deformable region tactilely distinguishable from the peripheral region in the expanded setting; a substrate coupled to the peripheral region and defining a fluid conduit and a fluid channel fluidly coupled to the fluid conduit, the fluid conduit adjacent the deformable region; a spring element coupled to the substrate between the tactile layer and the substrate, arranged substantially over the fluid conduit, and operable in a first distended position and a second distended position, the spring element at a local minimum of potential energy in the expanded setting and in the first distended position and at a second potential energy greater than the local minimum of potential energy between the first distended position and the second distended position, the spring element defining a nonlinear displacement response to an input displacing the deformable region in the expanded setting toward the substrate; a displacement device fluidly coupled to the fluid channel and displacing fluid into the fluid conduit to transition the spring element from the second distended position to the first distended position, the spring element thereby transitioning the deformable region from the retracted setting into the expanded setting, the spring element buckling from the first distended position to the second distended position in response to depression of the deformable region in the expanded setting; and a sensor outputting a signal corresponding to displacement of the deformable region toward the substrate.

### 2. Applications

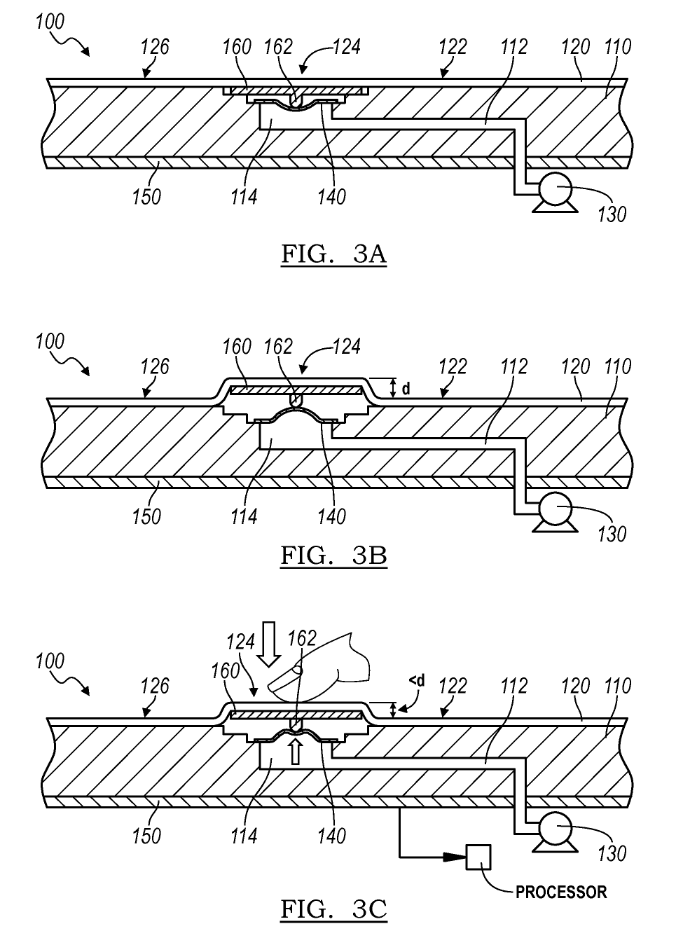

Generally, the dynamic tactile interface 100 functions as a physically reconfigurable input surface with input (i.e., deformable) regions that transition between flush (e.g., retracted) and raised (e.g., expanded) settings. The dynamic tactile interface 100 can also capture user inputs on the deformable region(s) to interact with a connected computing device. For example, the dynamic tactile interface 100 can be integrated into a computing device, such as an integrated keyboard, trackpad, or other input surface for a smartphone, a tablet, a laptop computer, a gaming device, a personal music player, etc. Alternatively, the dynamic tactile interface 100 can be integrated into a peripheral device (e.g., a peripheral accessory) for a computing device, such as a aftermarket interface configured for arrangement over a touchscreen in a smartphone or tablet or as an input surface for a standalone (i.e., peripheral) keyboard (shown in FIG. 3), mouse, trackpad, gaming controller, etc. for a computing or gaming device. Yet alternatively, the dynamic tactile interface 100 can be incorporated into a dashboard or other control surface within a vehicle (e.g., an automobile), a home appliance, a tool, a wearable device, etc.

In one example application, the dynamic tactile interface 100 is integrated into a peripheral keyboard, as shown in FIG. 3. In this example application, the tactile layer 120 can be substantially opaque and can define multiple deformable regions in a keyboard layout and fluidly coupled to the displacement device 130 via one or more fluid channels and fluid conduits, wherein each deformable region 124 corresponds to one alphanumeric and/or punctuation characters of an alphanumeric keyboard. Alphanumeric characters can be printed in ink over the deformable regions. The displacement device 130 can pump fluid into the fluid channel(s) and the fluid conduit(s) to transition (all or a selection of) the deformable regions from a retracted setting to an expanded setting to yield a surface similar to a standard keyboard. When a user depresses a particular expanded deformable region 124 in the set of deformable regions a corresponding haptic element 140 can yield a snap and/or click sensation (i.e., to mimic a common mechanical keyboard sensation), and the sensor 150 can output a signal corresponding to depression of the particular deformable region, the signal relayed to a connected laptop, desktop, tablet, or other connected computing device. Once the keyboard is no longer needed, the device can be disconnected, and/or the dynamic tactile interface 100 turned “OFF,” etc., the displacement device 130 can pump fluid out of the fluid channel(s) to return the deformable regions to the retracted setting. For example, when “OFF” with the deformable regions retracted, the peripheral keyboard with the dynamic tactile interface 100 can be substantially thin and substantially resistant to damage (e.g., scratches).

In a similar example application, the dynamic tactile interface 100 includes multiple deformable regions and is arranged within a laptop computer as an integrated keyboard. In this example application, when the laptop is powered “ON,” when the screen of the laptop is opened, and/or when an application or program accepting keystrokes executes, etc. the displacement device 130 can transition the deformable regions of the keyboard from the retracted setting to the expanded setting, the expanded deformable regions thus defining input regions corresponding to particular alphanumeric and/or punctuation characters. The dynamic tactile interface 100 can additionally or alternatively be incorporated into a mouse or trackpad area, wherein the displacement device 130 expands a planar surface corresponding to the trackpad and/or a fence or border around the trackpad area when the laptop is powered “ON,” when the screen of the laptop is opened, etc. Thus, in this example application, the tactile layer 120 can define a substantially planar surface across the keyboard-trackpad-palm rest surface of the laptop with the deformable regions in the retracted setting, and multiple deformable regions can transition to the expanded setting to define input regions when the device is in use. For example, the deformable regions can remain in the retracted setting when the screen of the device is closed such that the retracted keys (i.e., deformable regions) apply little pressure to the closed screen, which could damage the screen or prevent the screen from fully closing. In this example, the keys can then expand when the device and/or a particular application is in use, the dynamic tactile interface 100 thus capable of receiving inputs (e.g., depression of a particular deformable region) when the deformable regions are expanded and making the laptop substantially thin when closed and/or in the “OFF” setting with the deformable regions retracted.

In another example application, the dynamic tactile interface 100 is integrated into a gaming controller for a gaming system. In this example application, the tactile layer 120 can define multiple deformable regions that can be independently expanded and retracted, and the displacement device 130 can selectively expand deformable regions that correspond to inputs read by a current game played by a user. Similarly, when a gaming application executing on a mobile computing device (e.g., a smartphone or a tablet) incorporating the dynamic tactile interface 100, select deformable regions can expand and/or retract from the front of the device (e.g., over the display) and/or from the back of the device (e.g., adjacent the user's index fingers when the device is held in the landscape orientation). The dynamic tactile interface 100 can be similarly integrated into a mouse, a trackpad, a dashboard, or any other input device or surface connected to or integrated into a computing device. In this and the foregoing example applications, the haptic element 140 can be arranged adjacent the deformable region 124 in the fluid conduit 114 and can buckle (or snap) from the expanded setting to the retracted setting in response to depression of the deformable region 124 in the expanded setting, thereby yielding a nonlinear depression response at the deformable region 124 (e.g., a click feel. For example, the first magnet 141 can be integrated into the tactile layer 120 at the deformable region 124 and can be magnetically coupled to the second magnet 142 integrated into the substrate no adjacent the fluid conduit 114 and aligned with the deformable region. In another example, the spring element 144 can be arranged beneath the deformable region 124 over the fluid conduit, the spring element 144 buckling from the first configuration to the second configuration in response to depression of the deformable region 124 in the expanded setting.

### 3. Tactile Layer

The tactile layer 120 of the dynamic tactile interface 100 includes an attachment surface, a peripheral region, and a deformable region 124 adjacent the peripheral region, the deformable region 124 operable between a retracted setting and an expanded setting, the deformable region 124 in the expanded setting tactilely distinguishable from the peripheral region 122 and the deformable region 124 in the retracted setting. Generally, the tactile layer 120 functions to define one or more deformable regions arranged over a corresponding fluid conduit, such that displacement of fluid into and out of the fluid conduits (i.e., via the fluid channel) causes the deformable region(s) to expand and retract, respectively, thereby yielding a tactilely distinguishable formation on the tactile surface 126. The tactile surface 126 defines an interaction surface through which a user can provide an input to an electronic device that incorporates (e.g., integrates) the dynamic tactile interface 100. The deformable region 124 defines a dynamic region of the tactile layer, which can expand to define a tactilely distinguishable formation on the tactile surface 126 in order to, for example, guide a user input to an input region of the electronic device. The tactile layer 120 is attached to the substrate 110 across and/or along a perimeter of the peripheral region 122 (e.g., adjacent or around the deformable region) such as in substantially planar form. The deformable region 124 can be substantially flush with the peripheral region 122 in the retracted setting and elevated above the peripheral region 122 in the expanded setting, or the deformable region 124 can be arranged at a position offset vertically above or below the peripheral region 122 in the retracted setting.

The tactile layer 120 can be substantially opaque or semi-opaque, such as in an implementation in which the tactile layer 120 is applied over (or otherwise coupled to) a computing device without a display. For example, the substrate 110 can include one or more layers of colored opaque silicone adhered to a substrate 110 of aluminum. In this implementation, an opaque tactile layer 120 can yield a dynamic tactile interface 100 for receiving inputs on, for example, a touch sensitive surface of a computing device. The tactile layer 120 can alternatively be transparent, translucent, or of any other optical clarity suitable for transmitting light emitted by a display across the tactile layer. For example, the tactile layer 120 can include one or more layers of a urethane, polyurethane, silicone, and/or an other transparent material and bonded to the substrate no of polycarbonate, acrylic, urethane, PET, glass, and/or silicone, such as described in U.S. patent application Ser. No. 14/035,851. Thus, the tactile layer 120 can function as a dynamic tactile interface 100 for the purpose of guiding, with the deformable region, an input to a region of the display corresponding to a rendered image. For example, the deformable regions can function as a transient physical keys corresponding to discrete virtual keys of a virtual keyboard rendered on a display coupled to the dynamic tactile interface 100.

The tactile layer 120 can be elastic (or flexible, malleable, and/or extensible) such that the tactile layer 120 can transition between the expanded setting and the retracted setting at the deformable region. As the peripheral region 122 can be attached to the substrate 110, the peripheral region 122 can substantially maintain a configuration (e.g., a planar configuration) as the deformable region 124 transitions between the expanded setting and retracted setting. Alternatively, the tactile layer 120 can include both an elastic portion and a substantially inelastic (e.g., rigid) portion. The elastic portion can define the deformable region; the inelastic portion can define the peripheral region. Thus, the elastic portion can transition between the expanded and retracted setting and the inelastic portion can maintain a configuration as the deformable region 124 transitions between the expanded setting and retracted setting. The tactile layer 120 can be of one or more layers of PMMA (e.g., acrylic), silicone, polyurethane elastomer, urethane, PETG, polycarbonate, or PVC. Alternatively, the tactile layer 120 can be of one or more layers of any other material suitable to transition between the expanded setting and retracted setting at the deformable region.

The tactile layer 120 can include one or more sublayers of similar or dissimilar materials. For example, the tactile layer 120 can include a silicone elastomer sublayer adjacent the substrate no and a polycarbonate sublayer joined to the silicone elastomer sublayer and defining the tactile surface 126. Optical properties of the tactile layer 120 can be modified by impregnating, extruding, molding, or otherwise incorporating particulate (e.g., metal oxide nanoparticles) into the layer and/or one or more sublayers of the tactile layer.

As described in U.S. application Ser. No. 14/035,851, in the expanded setting, the deformable region 124 defines a tactilely distinguishable formation defined by the deformable region 124 in the expanded setting can be dome-shaped, ridge-shaped, ring-shaped, crescent-shaped, or of any other suitable form or geometry. The deformable region 124 can be substantially flush with the peripheral region 122 in the retracted setting and the deformable region 124 is offset above the peripheral region 122 in the expanded setting. When fluid is (actively or passively) released from behind the deformable region 124 of the tactile layer, the deformable region 124 can transition back into the retracted setting (shown in FIG. 1A). Alternatively, the deformable region 124 can transition between a depressed setting and a flush setting, the deformable region 124 in the depressed setting offset below flush with the peripheral region 122 and deformed within the fluid conduit, the deformable region 124 in the flush setting substantially flush with the deformable region. Additionally, the deformable regions can transition between elevated positions of various heights relative to the peripheral region 122 to selectively and intermittently provide tactile guidance at the tactile surface 126 over a touchscreen (or over any other surface), such as described in U.S. patent application Ser. No. 11/969,848, U.S. patent application Ser. No. 13/414,589, U.S. patent application Ser. No. 13/456,010, U.S. patent application Ser. No. 13/456,031, U.S. patent application Ser. No. 13/465,737, and/or U.S. patent application Ser. No. 13/465,772. The deformable region 124 can also define any other vertical position relative to the peripheral region 122 in the expanded setting and retracted setting.

As shown in FIG. 1A, one variation of the dynamic tactile interface 100 includes a (rigid) platen 160 coupled to the attachment surface at the deformable region 124 and movably arranged in the fluid conduit, the platen 160 supporting the deformable region 124 to define a planar surface across the deformable region in the expanded setting and to define a surface flush with the peripheral region in the retracted setting. Thus, the platen, which can be rigid, can be arranged within or coupled to the deformable region. Generally, the platen 160 can function to maintain a surface of the tactile layer 120 at the deformable region 124 in a substantially constant (e.g., planar) form between the expanded setting and retracted setting; a perimeter of the deformable region 124 between the peripheral region 122 and the platen 160 can, thus, stretch and shrink as the deformable region 124 transitions into the expanded setting and then back into the retracted setting. The platen 160 can be substantially thin, such as a planar puck (i.e., disc) coupled to the tactile layer 120 at the deformable region 124 opposite the tactile surface 126. In this implementation, the substrate 110 can define a recessed shelf under the tactile layer 120 and around the fluid conduit, and the platen 160 can engage the shelf with the tactile surface 126 at the deformable region 124 substantially flush with the tactile surface 126 at the peripheral region 122 in the retracted setting, as shown in FIG. 1A. Then, in this implementation, when the displacement device 130 pumps fluid into the fluid channel 112 to transition the deformable region 124 into the expanded setting, the platen 160 can rise off of the shelf and retain an area of the tactile surface 126 at the deformable region 124 in a planar form vertically offset from the peripheral region, a region of the deformable region 124 between the platen 160 and the peripheral region 122 (e.g., a region of the tactile layer 120 not bonded to the substrate 110 or to the platen) stretching to accommodate expansion of the deformable region, as shown in FIG. 1B. Thus, in this example, the platen 160 can function to yield a flat button across the deformable region 124 in the expanded setting. In a similar implementation, the tactile layer 120 includes two sublayers, and the platen 160 is arranged between the two sublayers at the deformable region 124 when the two sublayers are bonded together. The substrate no can similarly define a recess configured to accommodate the increased thickness of the deformable region 124 across the platen. Alternatively, in this implementation, one or both of the sublayers can be recessed across the platen 160 to yield a tactile layer 120 of substantially constant thickness. Yet alternatively, the platen 160 can extend into the fluid conduit, such as described in U.S. patent application Ser. No. 13/481,676. The platen 160 can also be hinged or otherwise coupled to the substrate 110 such that the deformable region 124 defines a planar surface not parallel (e.g., inclined against) the planar tactile surface 126 at the peripheral region 122 in the expanded setting. The platen 160 can also retain an area of the tactile surface 126 across the deformable region 124 in any other form, such as a curvilinear, stepped, or recessed form.

In the foregoing variation, the platen 160 can include a rigid transparent material (e.g., polycarbonate for the dynamic tactile interface 100 arranged over a display or touchscreen) or a rigid opaque material (e.g., acetal for the dynamic tactile interface 100 not arranged over a display or touchscreen). However, the platen 160 can be of any other material of any other form coupled to the deformable region 124 in any other suitable way.

However, the tactile layer 120 can be of any other suitable material and can function in any other way to yield a tactilely distinguishable formation at the tactile surface 126.

### 4. Substrate

The dynamic tactile interface 100 includes the substrate 110 coupled to the attachment surface at the peripheral region 122 and defining a fluid conduit 114 and a fluid channel 112 fluidly coupled to the fluid conduit, the fluid conduit 114 adjacent the deformable region. Generally, the substrate 110 functions to define a fluid circuit between the displacement device 130 and the deformable region 124 and to support and retain the peripheral region 122 of the tactile layer. Alternatively, the substrate 110 and the tactile layer 120 can be supported by a touchscreen once installed on a computing device. For example the substrate no can be of a similar material as and/or similarly or relatively less rigid than the tactile layer, and the substrate no and the tactile layer 120 can derive support from an adjacent touchscreen of a computing device. The substrate no can further define a support member to support the deformable region 124 against inward deformation past the peripheral region.

The substrate 110 can be substantially opaque or otherwise substantially non-transparent or translucent. For example, the substrate no can be opaque and arranged over an off-screen region of a mobile computing device. In another example application, the dynamic tactile interface 100 can be arranged in a peripheral device without a display or remote from a display within a device, and the substrate 110 can, thus, be substantially opaque. Thus, the substrate no can include one or more layers of nylon, acetal, delrin, aluminum, steel, or other substantially opaque material.

Alternatively (or additionally), the substrate no can be substantially transparent or translucent. For example, in one implementation, wherein the dynamic tactile interface 100 includes or is coupled to a display, the substrate no can be substantially transparent and transmit light output from an adjacent display. The substrate no can be PMMA, acrylic, and/or of any other suitable transparent or translucent material. The substrate no can alternatively be surface-treated or chemically-altered PMMA, glass, chemically-strengthened alkali-aluminosilicate glass, polycarbonate, acrylic, polyvinyl chloride (PVC), glycol-modified polyethylene terephthalate (PETG), polyurethane, a silicone-based elastomer, or any other suitable translucent or transparent material or combination thereof. In one application in which the dynamic tactile interface 100 is integrated or transiently arranged over a display and/or a touchscreen, the substrate no can be substantially transparent. For example, the substrate no can include one or more layers of a glass, acrylic, polycarbonate, silicone, and/or other transparent material in which the fluid channel 112 and fluid conduit 114 are cast, molded, stamped, machined, or otherwise formed.

Additionally, the substrate no can include one or more transparent or translucent materials. For example, the substrate no can include a glass base sublayer bonded to walls or boundaries of the fluid channel 112 and the fluid conduit. The substrate 110 can also include a deposited layer of material exhibiting adhesion properties (e.g., an adhesive tie layer or film of silicon oxide film). The deposited layer can be distributed across an attachment surface of the substrate 110 to which the tactile adheres and function to retain contact between the peripheral region 122 of the tactile layer 120 and the attachment surface of the substrate 110 despite fluid pressure raising above the peripheral region 122 the deformable region 124 and, thus, attempting to pull the tactile layer 120 away from the substrate no. Additionally, the substrate no can be substantially relatively rigid, relatively elastic, or exhibit any other material rigidity property. However, the substrate no can be formed in any other way, be of any other material, and exhibit any other property suitable to support the tactile layer 120 and define the fluid conduit 114 and fluid channel. Likewise, the substrate no (and the tactile layer) can include a substantially transparent (or translucent) portion and a substantially opaque portion. For example, the substrate no can include a substantially transparent portion arranged over a display and a substantially opaque portion adjacent the display and arranged about a periphery of the display.

The substrate no can define the attachment surface, which functions to retain (e.g., hold, bond, and/or maintain the position of) the peripheral region 122 of the tactile layer. In one implementation, the substrate no is planar across the attachment surface such that the substrate 110 retains the peripheral region 122 of the tactile layer 120 in planar form, such as described in U.S. patent application Ser. No. 12/652,708. However, the attachment surface of the substrate no can be of any other geometry and retain the tactile layer 120 in any other suitable form. For example, the substrate no can define a substantially planar surface across an attachment surface and a support member adjacent the tactile layer, the attachment surface retaining the peripheral region 122 of the tactile layer, and the support member adjacent and substantially continuous with the attachment surface. The support member can be configured to support the deformable region 124 against substantial inward deformation into the fluid conduit 114 (e.g., due to an input applied to the tactile surface 126 at the deformable region), such as in response to an input or other force applied to the tactile surface 126 at the deformable region. In this example, the substrate 110 can define the fluid conduit, which passes through the support member, and the attachment surface can retain the peripheral region 122 in substantially planar form. The deformable region 124 can rest on and/or be supported in planar form against the support member in the retracted setting, and the deformable region 124 can be elevated off of the support member in the expanded setting.

In another implementation, the support member can define the fluid conduit, such that the fluid conduit 114 communicates fluid from the fluid channel 112 through the support member and toward the deformable region 124 to transition the deformable region 124 from the retracted setting to the expanded setting.

The substrate no can define (or cooperate with the tactile layer, a display, etc. to define) the fluid conduit 114 that communicates fluid from the fluid channel 112 to the deformable region 124 of the tactile layer. The fluid conduit 114 can substantially correspond to (e.g., lie adjacent) the deformable region 124 of the tactile layer. The fluid conduit 114 can be machined, molded, stamped, etched, etc. into or through the substrate no and can be fluidly coupled to the fluid channel, the displacement device, and the deformable region. A bore intersecting the fluid channel 112 can define the fluid conduit 114 such that fluid can be communicated from the fluid channel 112 toward the fluid conduit, thereby transitioning the deformable region 124 from the expanded setting to the retracted setting. The axis of the fluid conduit 114 can be normal a surface of the substrate 110, can be non-perpendicular with the surface of the substrate no, of non-uniform cross-section, and/or of any other shape or geometry. For example, the fluid conduit 114 can define a crescent-shaped cross-section. In this example, the deformable region 124 can be coupled to (e.g., be bonded to) the substrate no along the periphery of the fluid conduit. Thus, the deformable region 124 can define a crescent-shape offset above the peripheral region 122 in the expanded setting.

The substrate no can define (or cooperate with the sensor, a display, etc. to define) the fluid channel 112 that communicates fluid through or across the substrate no to the fluid conduit. For example, the fluid channel 112 can be machined or stamped into the back of the substrate no opposite the attachment surface, such as in the form of an open trench or a set of parallel open trenches. The open trenches can then be closed with a substrate no backing layer, the sensor, and/or a display to form the fluid channel. A bore intersecting the open trench and passing through the attachment surface can define the fluid conduit, such that fluid can be communicated from the fluid channel 112 to the fluid conduit 114 (and toward the tactile layer) to transition the deformable region 124 (adjacent the fluid conduit) between the expanded setting and retracted setting. The axis of the fluid conduit 114 can be normal the attachment surface, can be non-perpendicular with the attachment surface, of non-uniform cross-section, and/or of any other shape or geometry. Likewise, the fluid channel 112 be parallel the attachment surface, normal the attachment surface, non-perpendicular with the attachment surface, of non-uniform cross-section, and/or of any other shape or geometry. However, the fluid channel 112 and the fluid conduit 114 can be formed in any other suitable way and be of any other geometry.

In one implementation, the substrate 110 can define a set of fluid channels. Each fluid channel 112 in the set of fluid channels can be fluidly coupled to a fluid conduit 114 in a set of fluid conduits. Thus, each fluid channel 112 can correspond to a particular fluid conduit 114 and, thus, a particular deformable region. Alternatively, the substrate no can define the fluid channel, such that the fluid channel 112 can be fluidly coupled to each fluid conduit 114 in the set of fluid conduits, each fluid conduit 114 fluidly coupled serially along the length of the fluid channel. Thus, each fluid channel 112 can correspond to a particular set of fluid conduits and, thus, deformable regions.

However, the suitable can be of any other suitable material and can function in any other way.

### 5. Displacement Device

The displacement device 130 of the dynamic tactile interface 100 is configured to displace fluid into the fluid channel 112 to transition the deformable region 124 from a retracted setting to an expanded setting, the deformable region 124 substantially flush with the peripheral region 122 in the retracted setting and elevated above the peripheral region 122 in the expanded setting. Generally, the displacement device 130 functions to pump fluid into and/or out of the fluid channel 112 transition the deformable region 124 into the expanded setting and retracted setting, respectively. The displacement device 130 can be fluidly coupled to the displacement device 130 via the fluid channel 112 and the fluid conduits and can further displace fluid from a reservoir (e.g., if the fluid is air, the reservoir can be ambient air from environment) toward the deformable region, such as through one or more valves, as described in U.S. patent application Ser. No. 13/414,589. For example, the displacement device 130 can pump a transparent liquid, such as water, silicone oil, or alcohol within a closed and sealed system. Alternatively, the displacement device 130 can pump air within a sealed system on in a system open to ambient air. For example, the displacement device 130 can pump air from ambient into the fluid channel 112 to transition the deformable region 124 into the expanded setting, and the displacement device 130 (or an exhaust valve) can exhaust air in the fluid channel 112 to ambient to return the deformable region 124 into the retracted setting.

The displacement device, one or more valves, the substrate 110, and/or the tactile layer 120 can also cooperate to substantially seal fluid within the fluid system to retain the deformable region 124 in the expanded and/or retracted settings. Alternatively, the displacement device, one or more valves, the substrate 110, and/or the tactile layer 120 can leak fluid (e.g., to ambient or back into a reservoir), and the displacement device 130 can continuously or occasionally or periodically pump fluid into (and/or other of) the fluid channel 112 to maintain fluid pressure with fluid channel 112 at a requisite fluid pressure to hold the deformable region 124 in a desired position.

The displacement device 130 can be electrically powered or manually powered and can transition one or more deformable regions into the expanded setting and retracted setting in response to any suitable input.

The dynamic tactile interface 100 can also include multiple displacement devices, such as one displacement device 130 that pumps fluid into the fluid channel 112 to expand the deformable region 124 and one displacement device 130 that pumps fluid out of the fluid channel 112 to retract the deformable region. However, the displacement device 130 can function in any other way to transition the deformable region 124 between the expanded setting and retracted setting.

In one variation, the dynamic tactile interface 100 includes a second displacement device 130 fluidly coupled to the fluid channel 112 and selectively displacing fluid into the fluid channel 112 to overcome magnetic attraction between the first magnet 141 and the second magnet 142 and transition the deformable region 124 from the retracted setting to the expanded setting.

A variation of the dynamic tactile interface 100 includes a bladder fluidly coupled to the fluid channel 112 and adjacent a back surface of the substrate no opposite the tactile layer. In this variation, the displacement device 130 can compress (or otherwise manipulate) the bladder to displace fluid from the bladder into the fluid channel 112 to transition the deformable region 124 from the retracted setting to the expanded setting, as described in U.S. patent application Ser. No. 14/552,312.

### 6. Haptic Element

The haptic element 140 of the dynamic tactile interface 100 is coupled to the substrate 110 and is configured to yield a nonlinear displacement of the deformable region 124 in the expanded setting toward the substrate no in response to application of a force on the deformable region 124 at the tactile surface 126. Generally, the haptic element 140 functions to alter a sensation (i.e., a force v. displacement response) of the deformable region 124 as the deformable region 124 is depressed (e.g., by a user). For example, the haptic element 140 can provide a non-linear button response to depression of the deformable region 124 in the expanded setting. In this example, the haptic element 140 can momentarily snap the expanded deformable region 124 into the retracted setting (or a lowered position above or below the retracted setting) once application of a force on the deformable region 124 (e.g., by a user) yields a threshold downward displacement of the deformable region. The haptic element 140 can, thus, function to mimic a sensation of a mechanical snap button, such as common to a key in a keyboard or another momentary switch.

### 6.1 Haptic Element: Passive Magnets

As shown in FIG. 1A, one implementation of the haptic element 140 includes a set of attractive components, such as a magnets and/or a ferrous material arranged within the substrate no and within the tactile layer. In one configuration, the haptic element 140 includes a first magnet 141 coupled to the substrate 110 proximal the deformable region; a second magnet 142 coupled to the tactile layer 120 at the deformable region 124 and nonlinearly attracted to the first magnet 141, the first magnet 141 and the second magnet 142 cooperating to yield a nonlinear relationship between a force to displace the deformable region 124 and a displacement of the deformable region 124 and cooperating to displace the deformable region 124 from the expanded setting toward the substrate 110 according to the nonlinear relationship and in response to an input to the deformable region 124 in the expanded setting.

The first magnet 141 can be arranged within the substrate no under (or adjacent, around, or in the fluid conduit 114 and the second magnet 142 arranged in the deformable region 124 over (or substantially aligned with) the first magnet 141, a pole of the second magnet 142 facing an opposite pole of the first magnet 141. For example, the second magnet 142 can be laminated between two sublayers of the tactile layer 120 or adhered to a back surface of the deformable region 124 opposite the tactile surface 126. In this example, the first magnet 141 can be molded into a first sublayer of the substrate 110, and the first sublayer of the substrate 110 can then be bonded to a second layer of the substrate 110. The second sublayer of the substrate 110 can also define an open channel and the fluid conduit 114 such that, when bonded to the second sublayer of the substrate 110, the first sublayer closes the open channel to define the fluid channel 112 with the first magnet 141 arranged under the fluid conduit. Alternatively, the first magnet 141 can be arranged loosely (i.e., not constrained in all six degrees of freedom) within the substrate 110, such as within a cylinder of vertical dimension substantially (e.g., 20%) greater that a maximum vertical dimension of the first magnet 141 and of a diameter slightly (e.g., 0.001″) greater than a diameter of the first magnet 141 such that the first magnet 141 can run vertically within the cylinder, such as the first magnet 141 and second magnet 142 approach (e.g., to provide a click sound and/or sensation) during depression of the deformable region, and such as the first magnet 141 and second magnet 142 separate during return of the deformable region 124 to the expanded setting. In one implementation, the second magnet 142 contacts the first magnet 141 in the retracted setting. The second magnet cooperates with the first magnet to draw the deformable region in the expanded setting toward the substrate according to a force increasing with a decrease in distance between the first magnet and the second magnet, the distance between the first magnet and the second magnet directly proportional to displacement of the deformable region.

In another configuration, the haptic element 140 includes the first magnet 141 arranged within the substrate 110 magnetically coupled to a ferrous material (e.g., a steel or iron insert) arranged within the tactile layer 120 and over the first magnet 141. Alternatively, the haptic element 140 can include a ferrous material (e.g., a ferrous platen 160 or insert) within the substrate no and the second magnet 142 arranged within the deformable region 124 over the ferrous material and magnetically coupled to the ferrous material. Yet alternatively, the haptic element 140 can include magnets and/or ferrous materials within the substrate 110 under and/or within the peripheral region 122 of the tactile layer. In these examples and configurations, the first magnet 141 and the second magnet 142 can be one or a combination of permanent magnets (e.g., a rage-earth magnets), electromagnets (e.g., coupled to a power supply within the device), or any other suitable type of magnet(s). For example, for the first and/or second magnet 142 that includes an electromagnet, a processor 170 can interface with the sensor 150 to detect an input on the tactile surface 126 and power all or only a corresponding electromagnet only when a touch is detected on the tactile surface 126. In particular, in this example, the processor 170 can interface with a touch sensor, a pressure sensor, or any other suitable type of sensor 150 to power the electromagnet(s) only when a deformable region 124 is actively depressed (e.g., rather when a finger is only resting on the tactile surface 126).

In the foregoing implementation(s), once the deformable region 124 is raised into the expanded setting, the dynamic tactile interface 100 can seal or otherwise maintain a substantially constant volume of fluid within the fluid circuit between the displacement device 130 and the deformable region 124 (e.g., from the outlet of the displacement device, through the fluid channel 112 and fluid conduits, and behind the deformable regions), thus defining a closed fluid system forward of the displacement device. A compressible fluid in this closed fluid system can, thus, compress, storing energy from depression (i.e., by a user) of the deformable region 124 back toward the substrate no in the form of increased fluid pressure. Additionally or alternatively, the substrate no (e.g., along the fluid channel 112 and the fluid conduit), the tactile layer 120 across one or more other deformable regions, etc. can elastically deform, storing energy (e.g., in the form of strain) as the deformable region 124 is depressed. When a depressive force on the deformable region 124 is released, the fluid, substrate no, and/or tactile layer 120 can release this stored energy back into the deformable region 124 to return the deformable region 124 to the expanded setting. Fluid pressure (and strain across the substrate no and/or the tactile layer) can also yield a resistive force against depression of the deformable region, such as a substantially linear force, that is, a force that varies linearly as a function of a depressed distance of the deformable region 124 initially in the expanded setting.

However, in this implementation, attraction between the magnetic and/or ferrous materials can yield a nonlinear attractive force such that attractive force between these haptic elements increases logarithmically, exponentially, or polynomically as the distance between the haptic elements closes. In particular, depression of the deformable region 124 occurs as a user applies to the deformable region 124 a force that is slightly greater than the resistive force yielded by the fluid, the substrate no, and/or the tactile layer. However, as the user continues to depress the deformable region, the haptic elements yield an attractive force that increases at a rate greater than the resistive force yielded by the fluid, the substrate 110, and/or the tactile layer. At a particular depression distance, the additional attractive force yielded by the haptic elements overcomes the additional resistive force yielded by the fluid, the substrate no, and/or the tactile layer, and the additional attractive force, in cooperation with the depressive force applied by the user to the deformable region, causes the deformable region 124 to snap into the retracted setting. Subsequently, when the user removes the depressive force (e.g., removes a finger or stylus) from the deformable region, the resistive force yielded by the fluid, the substrate no, and/or the tactile layer 120 overcomes the attractive force from the haptic elements and the deformable region 124 returns (e.g., snaps) back to the expanded setting.

In this implementation, the haptic elements can, thus, snap the deformable region 124 back to the retracted setting substantially quickly (e.g., with ˜150 milliseconds) once the equilibrium depression point is passed, and the fluid pressure and/or strain (from elastic deformation) in the fluid channel, in the fluid conduits, and/or in the tactile layer 120 at the deformable region(s) can return the deformable region 124 to the expanded setting substantially quickly (e.g., within ˜250 milliseconds). Thus, the haptic elements can cooperate with the fluid system of the dynamic tactile interface 100 to mimic a sensation of a common keyboard key. Additionally or alternatively, the haptic element 140 can yield a dip in a force-displacement curve of the deformable region 124 such that application of a constant force on the deformable region 124 (e.g., by a finger or stylus) depresses the deformable region 124 at a varying rate over the range of the deformable region.

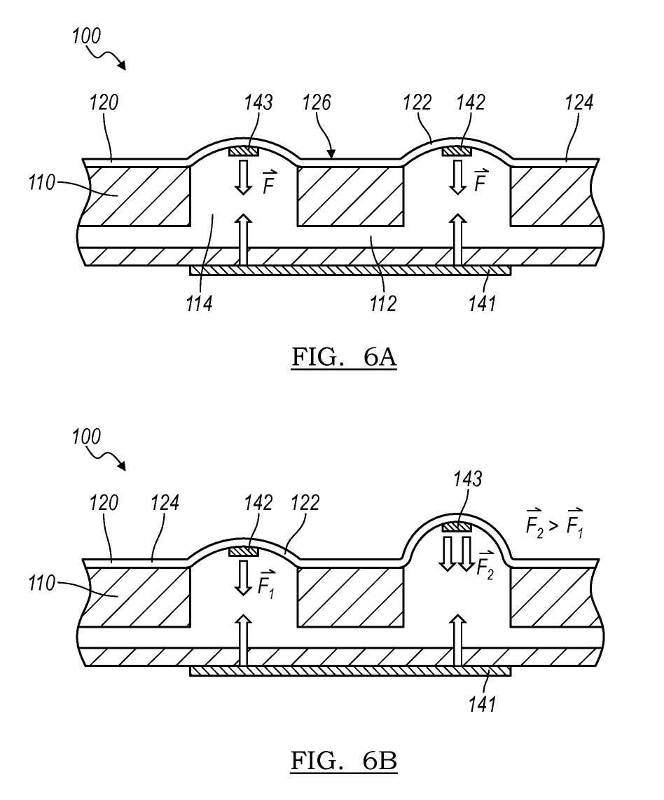

In one implementation of the dynamic tactile interface 100 shown in FIGS. 6A and 6B, the tactile layer 120 defines a second deformable region 124 adjacent the deformable region 124 and the peripheral region, the second deformable region 124 operable between the expanded setting and the retracted setting. The substrate 110 can define a second fluid channel 112 and a second fluid conduit 114 fluidly coupled to the second fluid channel 112 and adjacent the second deformable region. The displacement device 130 can fluidly couple to the second fluid channel 112 (e.g., be attached at an end of the second fluid channel) and displace fluid into the second fluid conduit 114 to transition the second deformable region 124 from the retracted setting to the expanded setting. The deformable region 124 can be at a first height above the peripheral region 122 in the expanded setting and the second deformable region 124 can be at a second height above the peripheral region 122 in the expanded setting, the second height greater than the first height. The first magnet 141 can be proximal the deformable region 124 and the second deformable region. A third magnet 143 can be coupled to the second deformable region 124 (e.g., embedded in, adhered to the tactile layer) and magnetically attracted to the first magnet 141, the third magnet 143 exhibiting a greater magnetic strength than the second magnet 142. Thus, the first magnet 141 and the third magnet 143 can both be attracted to a same magnet (the second magnet 142).

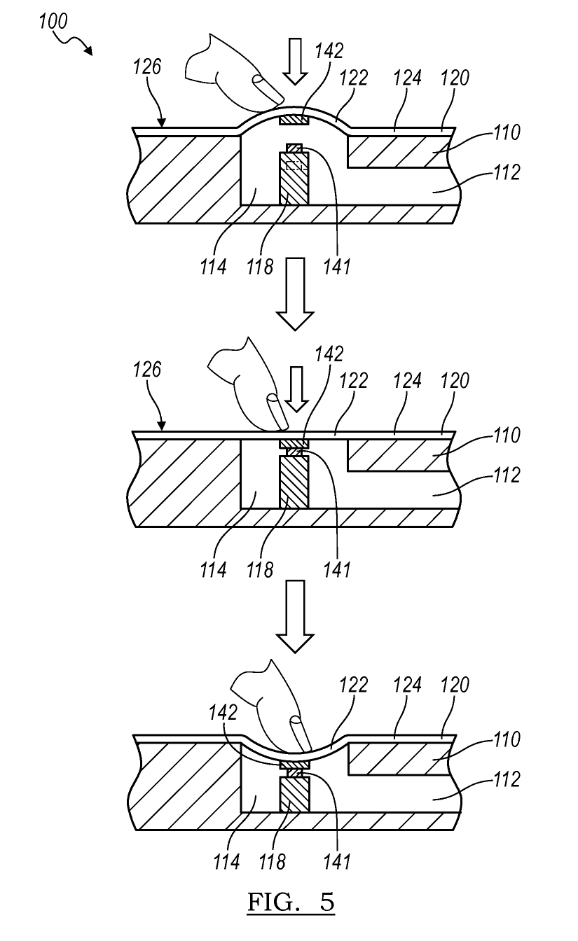

In another implementation shown in FIG. 5, a compressible member 118 can be coupled to the substrate no and arranged in the fluid conduit, the first magnet 141 coupled to a surface of the compressible member, the compressible member 118 compressed away from the tactile layer 120 in the retracted setting and expanded toward the tactile layer 120 in the expanded setting, the compressible member 118 (nonlinearly or linearly) resisting transition of the deformable region 124 from the expanded setting to the retracted setting. The compressible member 118 can be a flexure, the flexure deflecting toward the deformable region in the expanded setting and deflecting toward a base of the substrate in the retracted setting.

In an example of the foregoing implementation, the compressible member 118 can include a column arranged in the fluid conduit 114 and extending toward the deformable region 124 and normal the peripheral region, an end of the column proximal the deformable region 124 offset below the peripheral region. The column can be physically coextensive with the substrate 110. Thus, a user can depress the deformable region 124 into the fluid conduit 114 toward the compressible member, the deformable region 124 engaging the compressible member 118 in the retracted setting. The column, which can be of a porous and compressible polymer material or can be a spring, can compress toward the substrate 110 at a nonlinear displacement rate. Thus, when a user depresses the deformable region 124 in the expanded setting toward the substrate 110, magnetic attraction between the first magnet 141 and the second magnet 142 can cause the deformable region 124 to snap (or buckle) to the retracted setting. However, the user can continue to compress the compressible member 118 toward the substrate 110 beyond the retracted setting to a second retracted setting, thereby increasing a throw-distance (i.e., a distance the deformable region 124 travels) from a distance the deformable region 124 travels from the expanded setting to the retracted setting to a increased distance the deformable region 124 travels from the expanded setting to the second retracted setting. However, the compressible member 118 can be of any other geometry and be of any other material suitable to support the deformable region 124 and nonlinearly (and partially) resist deformation into the fluid conduit.

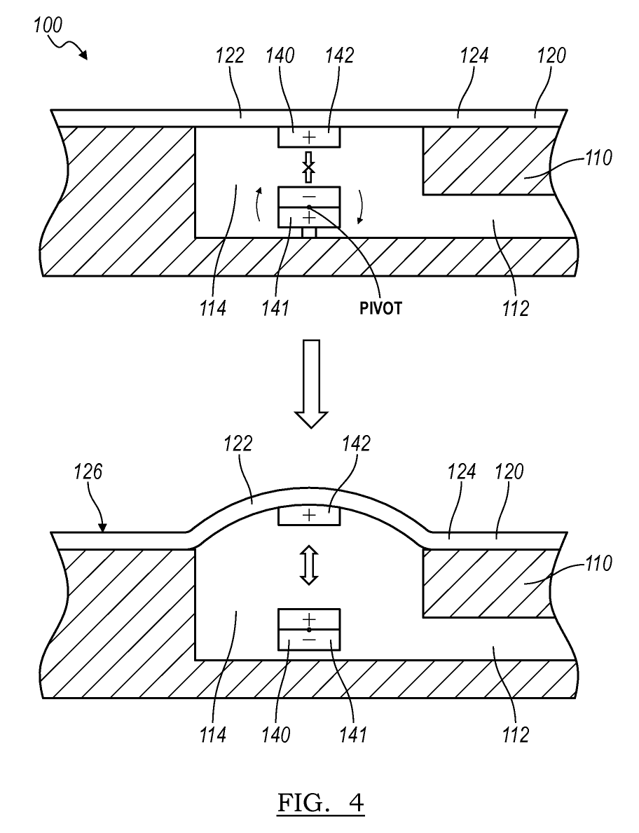

In another implementation shown in FIG. 4, the dynamic tactile interface 100 can include a pivot coupled to the substrate 110 and arranged in the fluid conduit. The pivot can rotate between a first configuration and a second configuration. Furthermore, the pivot can be coupled to an electromechanical motor configured to rotate the pivot in response to a detected input at the deformable region, removal of the input from the deformable region, or any other trigger event detected by a sensor 150 (coupled to the tactile layer) or a pressure sensor 150 (fluidly coupled to the fluid channel). For example, the pivot can be rotate with pulses of fluid directed at a surface of the first magnet, the first magnet rotating about the pivot. The displacement device or a second displacement device (e.g., a pump) can pulse fluid in the direction of the surface of the first magnet. The pivot can support the first magnet with a first pole of the first magnet adjacent the second magnet to attract the second magnet in a first configuration and support the first magnetic with a second pole of the magnet adjacent the second magnet to repel the second magnet in a second configuration, the pivot rotating between the first configuration and the second configuration in response to a detected input on the tactile layer. The pivot can rotate to the first configuration in response to a first detected input at the deformable region 124 (e.g., depression of the deformable region 124 in the expanded setting toward the substrate no) and rotates to the second configuration in response to a second detected input at the deformable region 124 (e.g., a second depression of the deformable region 124 in the retracted setting toward the substrate 110. Thus, the dynamic tactile interface 100 can function to define a toggle switch at the deformable region.

In another implementation, the haptic element 140 can include a spacer arranged between the first magnet 141 and second magnet 142 (and/or ferrous elements) to control a maximum attractive force between the magnets. The spacer can be of a static thickness or automatically or manually controlled to adjust a maximum attractive force between the first and second elements as the deformable region 124 is depressed in the expanded setting. Alternatively, the first magnet 141 and second magnet 142 can contact in the retracted settings and/or in the fully-depressed state in the expanded setting. In the expanded setting, the first magnetic and the second magnet can exhibit an attractive force less than a force to displace fluid from the fluid channel in the expanded setting. Thus, even in the expanded setting, the second magnet 142 can exert an attractive force on the first magnet 141. However, the attractive force can be less than a force to displace the deformable region 124 toward the substrate no. Thus, the second magnet 142 can be attracted to the first magnet 141 in the expanded setting and, yet, also stable in the expanded setting as the attractive force can be less strong that the force to displace the deformable region 124 toward the substrate no.

In another example, the tactile layer 120 can define the deformable region 124 offset below the peripheral region 122 in the retracted setting and offset above the peripheral region 122 in the expanded setting. The first magnet and the second magnet further cooperate to retain the deformable region in the retracted setting in response to removal of an input from the deformable region; and the displacement device 130 can displace fluid into the fluid channel to overcome an attractive force between the first magnet and the second magnet to transition the deformable region from the retracted setting to the expanded setting. In this example, the deformable region can define an exterior surface flush with an exterior surface of the peripheral region in the retracted setting

### 6.2 Haptic Element: Active Magnets

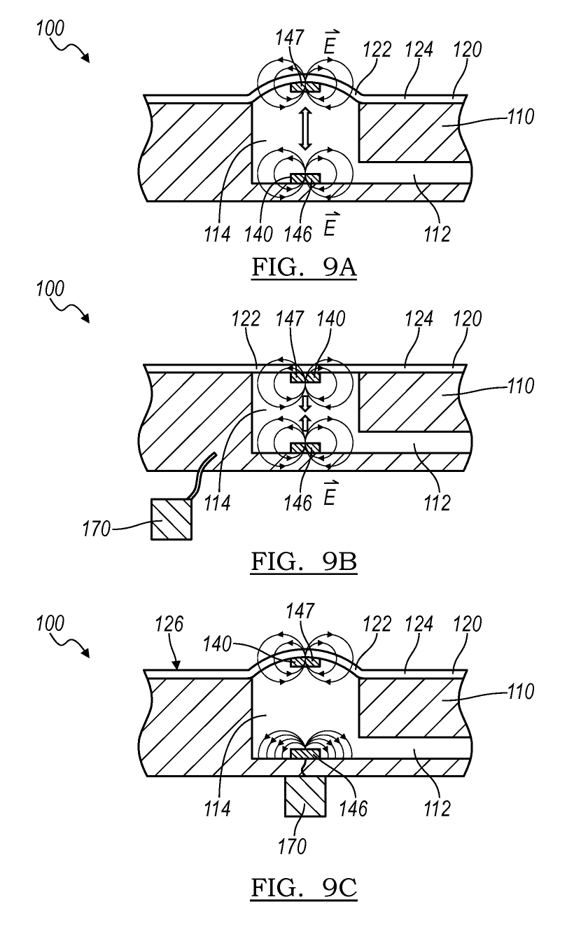

As shown in FIGS. 9A, 9B, and 9C, in another variation, the haptic element 140 can include a first electromagnetic element 146 coupled to the substrate 110 proximal the deformable region 124 and outputting a first electromagnetic field; and a second electromagnetic element 147 coupled to the tactile layer 120 at the deformable region 124 and outputting a second electromagnetic field, the second electromagnetic element 147 nonlinearly attracted to the first electromagnetic element 146 in a first setting and nonlinearly repelling the first electromagnetic element 146 in a second setting. The dynamic tactile interface 100 can also include (shown in FIGS. 9A and 9B) a processor electrically coupled to the first electromagnetic element and to the second electromagnetic element, configuring the first electromagnetic element and the second electromagnetic element in the second setting to guide transition of the deformable region from the retracted setting to the expanded setting, and configuring the first electromagnetic element and the second electromagnetic element in the first setting to draw the deformable region toward the substrate in response to an input on the de in the expanded setting; and a displacement device 130 fluidly coupled to the fluid channel 112 and configured to displace fluid into the fluid channel 112 to transition the deformable region 124 from a retracted setting to an expanded setting. Generally, the first electromagnetic element 146 and the second electromagnetic element 147 function to dynamically alter a sensation (i.e., a force v. displacement response) of the deformable region 124 as the deformable region 124 is depressed (e.g., by a user). Thus, the first electromagnetic element 146 and the second electromagnetic element 147 can provide a non-linear button response to depression of the deformable region 124 in the expanded setting through dynamic variation of the first electromagnetic field and the second electromagnetic field. The processor can transition the first magnetic element and the second magnetic element from the first setting to the second setting in response to a trigger event; wherein the deformable region is offset above the peripheral region in the expanded setting and offset below the peripheral region in the retracted setting, the deformable region transitioning from the retracted setting to the expanded setting in response to the trigger event. For example, the processor transitions the first magnetic element and the second magnetic from the first setting to the second setting in response to the trigger event including depression of the deformable region in the retracted setting toward the substrate.

In this variation, the haptic element 140 includes an electromagnetic element, and the dynamic tactile interface 100 powers the electromagnetic element when the (attached) computing device is in use to mimic a snap effect at the deformable region, as described above. In this implementation, dynamic tactile interface 100 can be arranged over a display (as described in U.S. patent application Ser. No. 13/414,589), the substrate 110 and the tactile layer 120 can be substantially transparent, and the haptic element 140 can include a transparent conductive circuit arranged over or within the tactile layer 120 and a power supply that supplies power to the transparent conductive circuit to generate a magnetic field. For example, the transparent conductive circuit can include an indium tin oxide (ITO) coil (or silver nanowire) printed between transparent silicone sublayers of the tactile layer 120 such that current driven through the ITO coil yields a magnetic field that attracts a magnet, a ferrous material, and a second powered transparent coil within the substrate 110. In this implementation, the dynamic tactile interface 100 can further manipulate a current flux through the transparent coil to control a magnitude of the magnetic field output by the transparent coil—and therefore a magnitude of an attractive force between the deformable layer and the substrate 110.

In the foregoing implementation, the haptic element 140 can include a spacer arranged between the first magnet 141 and the second magnet 142 (and/or ferrous elements) to control a maximum attractive force between the magnets. The spacer can be of a static thickness or automatically or manually controlled to adjust a maximum attractive force between the first electromagnetic element 146 and the second electromagnetic element 147 as the deformable region 124 is depressed in the expanded setting. Alternatively, the first magnet 141 and the second magnet 142 can contact in the retracted settings and/or in the fully-depressed state in the expanded setting.

In one implementation of the foregoing variation, a first electromagnetic element 146 (e.g., silver nanowire) couples to (e.g., bonds or adheres to) the substrate 110 proximal the deformable region 124 and outputting a first electromagnetic field; a second electromagnetic element 147 coupled to the tactile layer 120 (e.g., bonds or adheres to) at the deformable region 124 and outputting a second electromagnetic field, the second electromagnetic element 147 nonlinearly attracted to the first electromagnetic element 146 in a first setting and nonlinearly repelling the first electromagnetic element 146 in a second setting. Thus, the first electromagnetic element 146 and the second electromagnetic element 147 can be attracted and repelled by a varying (e.g., nonlinear) force. The varying force can vary linearly or nonlinearly with distance (between electromagnetic elements), over time (e.g., duration of an electromagnetic field output), or with any other suitable variable. The dynamic tactile interface 100 can also include a processor 170 electrically coupled the first electromagnetic element 146 and the second electromagnetic element 147. The processor 170 can control the first electromagnetic field and the second electromagnetic field and configure the first setting to transition the deformable region 124 from the retracted setting to the expanded setting and configure the second setting to transition the deformable region 124 from the expanded setting to the retracted setting. Thus, the processor 170 and the electromagnetic elements can cooperate to define a displacement device 130 for the deformable region. Alternatively, the dynamic tactile interface 100 can also include a (disparate) displacement device 130 fluidly coupled to the fluid channel 112 and configured to displace fluid into the fluid channel 112 to transition the deformable region 124 from a retracted setting to an expanded setting. The dynamic tactile interface 100 can also include a sensor 150 outputting a signal corresponding to displacement of the deformable region 124 (e.g., due to a user depressing the deformable region) toward the substrate no. The processor 170 can electrically couple to the sensor 150 and configure the first setting in response to the signal from the sensor. The processor 170 can also dynamically vary a magnitude of the first electromagnetic field and a magnitude of the second electromagnetic field to yield a nonlinear displacement response of the deformable region 124 in response to depression of the deformable region 124 in the expanded setting toward the substrate 110. The nonlinear displacement response can manifest as a nonlinear rate of displacement toward the substrate no or a nonlinear strain across the deformable region 124 as the deformable region 124 deforms toward the substrate no. The first and second electromagnetic element 147s can illicit the nonlinear displacement response based on magnetic field strength and, thus, attractive force between the first and second electromagnetic element 147s. Furthermore, the second electromagnetic element 147 can contact the first electromagnetic element 146 in the retracted setting.

In one example of the foregoing implementation, the second magnet 142ic element transitions from the second setting to the first setting in response to a trigger event. The deformable region 124 can be offset above the peripheral region 122 in the expanded setting and offset below the peripheral region 122 in the retracted setting, the deformable region 124 transitioning from the retracted setting to the expanded setting in response to the trigger event. The trigger event can include depression of the deformable region 124 in the retracted setting toward the substrate no.

In another example, the tactile layer 120 further includes a second deformable region 124 adjacent the deformable region 124 and the peripheral region, the second deformable region 124 operable between the expanded setting and the retracted setting. The substrate 110 defines a second fluid channel 112 and a second fluid conduit 114 fluidly coupled to the second fluid channel 112 and adjacent the second deformable region. The displacement device 130 fluidly couples to the second fluid channel 112 and displaces fluid into the second fluid conduit 114 to transition the second deformable region 124 from the retracted setting to the expanded setting, the deformable region 124 at a first height above the peripheral region 122 in the expanded setting and the second deformable region 124 at a second height above the peripheral region 122 in the expanded setting, the second height greater than the first height. In this example, the dynamic tactile interface 100 also includes a third electromagnetic element coupled to the second deformable region 124 and magnetically attracted to the first electromagnetic element 146, the third electromagnetic element outputting a third electromagnetic field of a magnitude greater than the second electromagnetic field. Thus, the deformable region 124 and the second deformable region 124 can be offset above the peripheral region 122 by different heights and electromagnetic field strength can cooperate with the displacement device 130 to transition the deformable region 124 and the second deformable region 124 between the retracted setting and the expanded setting. Without electromagnetic elements, the displacement device 130 exerts a greater force to displace the second deformable region 124 than the deformable region. With electromagnetic elements, the displacement device 130 can displace the deformable region 124 and the second deformable region 124 at an equal force.

In another implementation, a second electromagnetic element can be coupled to the tactile layer at the deformable region and magnetically attracted to the first electromagnetic element in a first setting and magnetically repelling the first electromagnetic element in a second setting, the first electromagnetic element and the second electromagnetic element cooperating to displace the deformable region from the expanded setting toward the substrate at a nonlinear displacement rate in response to depression of the deformable region in the expanded setting toward the substrate. The first electromagnetic element 146 and the second electromagnetic element 147 can cooperate to displace the deformable region 124 (i.e., with or without a displacement device) from the expanded setting toward the substrate 110 in the first configuration at a nonlinear displacement rate in response to depression of the deformable region 124 in the expanded setting toward the substrate no. In this implementation, the dynamic tactile interface 100 can also include a sensor 150 outputting a first signal corresponding to depression of the deformable region 124 toward the substrate no and a second signal corresponding to a trigger event; and a processor 170 electrically coupled to the second electromagnetic element 147 and controlling the second electromagnetic element 147, the processor 170 configuring the first setting in response to the first signal and configuring the second setting in response to the second signal. The trigger event can include a second input to the deformable region. Thus, the deformable region 124 can function as a toggle switch. Alternatively, the trigger event can include removal of an input from the deformable region.

In another implementation, a processor 170 can electrically couple to the first electromagnetic element 146 and the second electromagnetic element 147 and control the first electromagnetic field and the second electromagnetic field, the processor 170 dynamically altering the first strength and the second strength to yield a nonlinear rate of displacement (e.g., over a particular time period) of the deformable region 124 toward the substrate no in response to depression of the deformable region 124 in the expanded setting toward the substrate no.

In another implementation, the first electromagnetic element is capacitively coupled to the deformable region, a capacitance between first electromagnetic element and the deformable region decaying in response to an input to the tactile layer (shown in FIGS. 9A, 9B, and 9C), the capacitance decaying in response to an input to the tactile layer, the first electromagnetic element 146 defining a capacitive sensor. The first electromagnetic element can also be capacitively coupled to the second electromagnetic element, a capacitance between the first electromagnetic element and the second electromagnetic element decaying in response to the tactile layer. Likewise, the second electromagnetic can output a signal, the signal decaying in response to an input to the tactile layer. Thus, the second electromagnetic can function a capacitive sensor. Additionally or alternatively, the first electromagnetic element 146 and the second electromagnetic element 147 can cooperate to define a capacitive sensor, which can detect a location of an input to the tactile layer 120 and a depth into the substrate 110 (or magnitude) of the input to the tactile layer 120 as the second electromagnetic element 147 can be offset below the second electromagnetic element 147 by a particular depth.

In another implementation, the processor intermittently communicates an electrical pulse to the second electromagnetic element to configure the second electromagnetic element in the second setting, the second electromagnetic element outputting a second electromagnetic field persistent over a period of time in response to receiving an electrical pulse.

In another implementation, the first electromagnetic is embedded in the tactile layer proximal a center of the deformable region.

In another implementation, the second electromagnetic element is operable in a third setting, the second electromagnetic element outputting a third electromagnetic field of a magnitude substantially less than the second electromagnetic field in the third setting. In this implementation, the processor selectively configures the second electromagnetic element in the second setting in response to execution of a first process on a computing device coupled to the processor and the processor selectively configures the second electromagnetic element in the third setting in response to execution of a second process distinct from the first process on the computing device. For example, the processor can configure the second electromagnetic element in the second setting in response to execution of a text input application on the computing device; and wherein the processor configures the second electromagnetic element in the third setting in response to closure of the text input application on the computing device.

In another implementation, the dynamic tactile interface further includes a compressible member (as described above) coupled to the substrate and arranged in the fluid conduit, the first electromagnetic element coupled to a surface of the compressible member, the compressible member compressed away from the tactile layer in the retracted setting and expanded toward the tactile layer in the expanded setting, the compressible member nonlinearly resisting transition of the deformable region from the expanded setting to the retracted setting.

However, the first electromagnetic element 146 and the second electromagnetic element 147 can include any other one or more elements and function in any other way to effect a particular (e.g., non-linear) haptic feel in response to depression of the deformable region.

### 6.3 Haptic Element: Bistable Spring

The haptic element 140 of the dynamic tactile interface 100 can be coupled to the substrate 110 and can be configured to yield a nonlinear displacement of the deformable region 124 in the expanded setting toward the substrate 110 in response to application of a force on the deformable region 124 at the tactile surface 126. Generally, the haptic element 140 functions to alter a sensation (i.e., a force v. displacement response) of the deformable region 124 as the deformable region 124 is depressed (e.g., by a user). For example, the haptic element 140 can provide a non-linear button response to depression of the deformable region 124 in the expanded setting. In this example, the haptic element 140 can momentarily snap the expanded deformable region 124 into the retracted setting (or a lowered position above or below the retracted setting) once application of a force on the deformable region 124 (e.g., by a user) yields a threshold downward displacement of the deformable region. The haptic element 140 can, thus, function to mimic a sensation of a mechanical snap button, such as common to a key in a keyboard or another momentary switch. In particular, the haptic element 140 can effect a dip in a force-displacement curve of the deformable region 124 such that application of a constant force on the deformable region 124 (e.g., by a finger or stylus) depresses the deformable region 124 at a varying rate over the range of the deformable region.

In another implementation, the haptic element 140 includes a spring element coupled to the substrate between the tactile layer and the substrate, arranged substantially over the fluid conduit, and operable in a first distended position and a second distended position, the spring element at a local minimum of potential energy in the expanded setting and in the first distended position and at a second potential energy greater than the local minimum of potential energy between the first distended position and the second distended position, the spring element defining a nonlinear displacement response to an input displacing the deformable region in the expanded setting toward the substrate; and the dynamic tactile interface 100 includes a displacement device fluidly coupled to the fluid channel and displacing fluid into the fluid conduit to transition the spring element from the second distended position to the first distended position, the spring element thereby transitioning the deformable region from the retracted setting into the expanded setting, the spring element buckling from the first distended position to the second distended position in response to depression of the deformable region in the expanded setting.

In a similar implementation, the haptic element 140 includes a spring element 144 coupled to the substrate no between the tactile layer 120 and the substrate 110 and arranged substantially over the fluid conduit, the spring element 144 defining a first distended position below an equilibrium plane and defines a second distended position above the equilibrium plane, the deformable region 124 conforming to the spring element, the spring element 144 defining a nonlinear displacement response to an input displacing the deformable region 124 in the expanded setting toward the substrate no. The equilibrium plane can be offset above the peripheral region 122 by a first height, the first distended position is offset above the peripheral region 122 by a second height less than the first height, and the second distended position is offset above the peripheral region 122 by a third height greater than the first height. Alternatively the equilibrium plane can be flush with the peripheral region, thereby defining a substantially continuous and flush surface in the retracted setting. In this implementation, the spring element 144 in the first distended position supports the deformable region 124 in the retracted setting and the spring element 144 in the second distended position supports the deformable region 124 in the expanded setting. The spring element can be substantially transparent, translucent, or opaque or any combination thereof.

The haptic element 140 can include a (bi-stable) spring element 144 arranged within (or over) the fluid channel 112 between the tactile layer 120 and the substrate no. In one example of this implementation shown in FIGS. 3A, 3B, and 3C, the haptic element 140 can define a spring element 144 stable in a first distended position below an equilibrium plane (shown in FIG. 3A) and stable in a second distended position above the equilibrium plane across the spring element 144 (shown in FIG. 3B). Alternatively the spring element can be substantially stable in the first distended position and substantially unstable in the second distended position. In this example, the haptic element 140 can be sealed over the fluid channel 112 such that displacement of fluid into the fluid channel 112 (i.e., increased fluid pressure within the fluid channel) transitions the haptic element 140 into the second distended position and such that displacement of fluid out of the fluid channel 112 (i.e., decreased fluid pressure within the fluid channel) transitions the haptic element 140 into the first distended position. Alternatively, a center of the spring element in the first distended position can be arranged above an equilibrium plane and the center of the spring element in the second distended position can be arranged below the equilibrium plane in the second distended position, the spring element stable in the first distended position and in the second distended position. Thus, the center of the spring element in the first distended position can be offset below the peripheral region by a first distance and the center of the spring element in the second distended position can be offset below the peripheral region by a second distance greater than the first distance

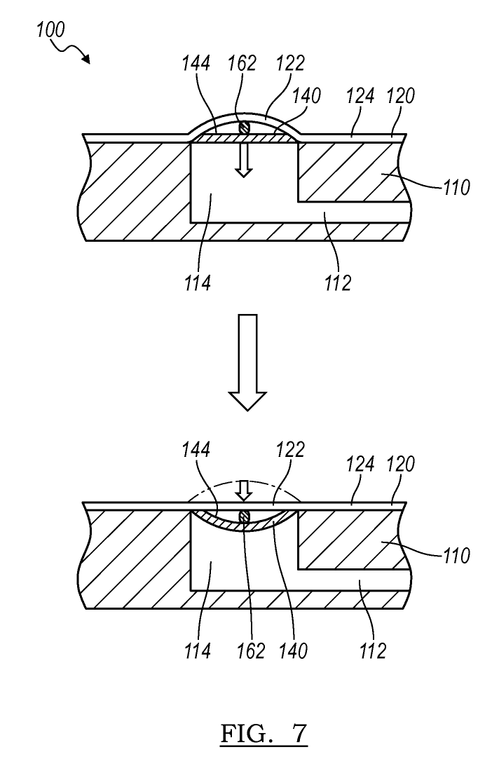

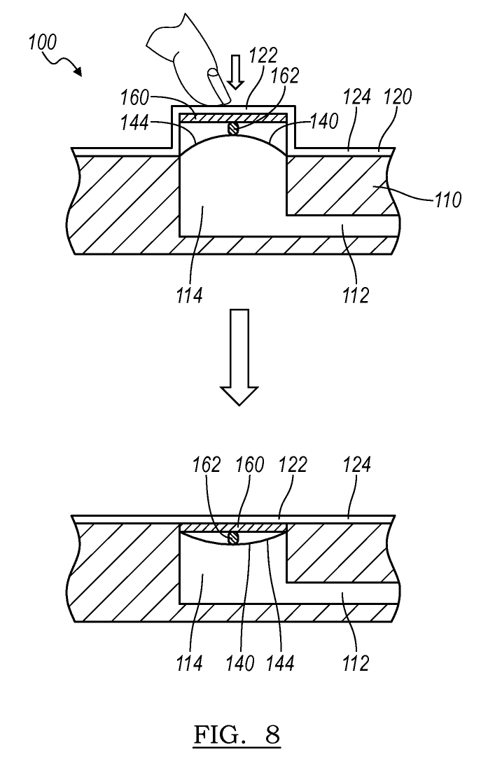

The tactile layer 120 can further define a follower 162 (shown in FIGS. 3A and 7) arranged over and extending toward the haptic element 140 by a distance approximating a maximum normal distance between the equilibrium plane and the concave surface of the distended haptic element 140 in the first distended position. The follower 162 can be coupled to the spring element 144 and arranged between the spring element 144 and the deformable region, the follower communicating forces between the spring element and the deformable region. Thus, in the retracted setting, the follower 162 can rest into the interior of the haptic element 140 in the first (stable) distended position. For example, the spring element 144 can define a divot adjacent the follower, the follower 162 resting in the divot in the first distended position. However, when fluid is pumped into the fluid channel, the haptic element 140 can transition into the second distended position, the follower 162 transfers an upward force from the haptic element 140 into the deformable region 124 to transition the deformable region 124 into the expanded setting. The follower 162 can be coupled to the platen 160 described above—such as extending substantially normal to the surface and proximal a center of the platen 160—to yield a substantially planar surface across the deformable region 124 in the expanded setting, as shown in FIG. 8.

Furthermore, in the foregoing example, the dynamic tactile interface 100 can include a volume of fluid supported by the fluid conduit 114 and the fluid channel, the displacement device 130 displacing the volume of fluid in response to the spring element 144 transitioning from the first distended position to the second distended position and a second volume of fluid supported by the fluid conduit 114 and the fluid channel, the displacement device 130 displacing the second volume of fluid to transition the deformable region 124 from the retracted setting to the expanded setting, the second volume of fluid greater than the volume of fluid. Thus, the volume of fluid displaced into the fluid channel 112 to transition the haptic element 140 from the first distended position into the second distended position can be substantially less than a swept volume (i.e., the second volume of fluid) of the deformable region 124 between the retracted and expanded settings, thereby limiting a time and/or total volume of fluid required to transition one or more such deformable regions between the retracted and expanded settings. Furthermore, in this example, with the deformable region 124 in the expanded setting and the haptic element 140 in the second distended position, depression of the deformable region 124 by a user (e.g., by a finger or stylus) can be resisted by the haptic element 140 (via the follower) until a threshold force at which the haptic element 140 buckles is achieved, at which point the haptic element 140 (momentarily) returns to the retracted setting. In this example, while the dynamic tactile interface 100 is in use, the displacement device 130 can substantially continuously maintain fluid pressure within the fluid circuit above a threshold pressure to maintain the haptic element 140 in the second distended position such that the haptic element 140 returns to the second distended position substantially quickly after a user removes the stylus or finger from the deformable region.

In the foregoing implementation, the follower 162 can be attached to the tactile layer 120 or to the platen 160 by bonding, such as with a pressure sensitive adhesive, an elastic epoxy, or in any other suitable way, such as to handle changes in shape of the spring element 144 during operation of the dynamic tactile interface 100.

Furthermore, as described above, the spring element 144 can seal over the fluid conduit. Alternatively, the spring element 144 can be permeable to the fluid or the fluid channel 112 can be otherwise open to the fluid channel, such that fluid can flow behind the deformable region 124 to expand the deformable region. Thus, fluid can communicate between the fluid conduit 114 and a cavity between the spring element 144 and the deformable region. The spring element 144 can also be coupled to the deformable region 124 (e.g., via the follower) such that the spring element 144 rises with the deformable region 124 into the expanded setting and yields a non-linear resistive force as the deformable region 124 is depressed back into the retracted setting. Once the deformable region 124 is depressed, the spring element 144 can retain the deformable region 124 in the retracted setting, or the spring element 144 can release the deformable region 124 back into the expanded setting. For example, the displacement device 130 can displace fluid into the fluid channel 112 at a first rate and fluid can communicate between the cavity and the fluid conduit 114 at a second rate slower than the first rate. When the displacement device 130 displaces fluid into the fluid channel 112 at the first rate transitioning the spring element 144 to the expanded setting at a first expansion rate, the spring element 144 draws a vacuum in the cavity, the deformable region 124 transitioning to the expanded setting at a second expansion rate slower than the first expansion rate. Likewise, the displacement can displace fluid from the fluid channel 112 at the first rate, transitioning the spring element 144 from the expanded setting to the retracted setting at a first retraction rate and to draw fluid from the cavity, the displacement device 130 drawing a vacuum in the fluid channel, the deformable region 124 transitioning from the expanded setting to the retracted setting at a second retraction rate in response to fluid in the cavity communicating from the cavity to the fluid channel 112 at the second rate, the second retraction rate slower than the first retraction rate.

In another implementation, the spring element 144 can support the deformable region in the expanded setting against an input force of magnitude less than a threshold magnitude applied to the deformable region. In this implementation, the spring element buckles from the first distended position to the second distended position in response to an input force of magnitude greater than the threshold magnitude applied to the deformable region and the deformable region transitions from the expanded setting to the retracted setting in response to the spring element buckling from the first distended position to the second distended position. Thus, the deformable region 124 transitions from the expanded setting to the retracted setting in response to the spring element 144 buckling from the expanded setting to the retracted setting.

In a similar example of the foregoing implementation, the haptic element 140 includes a spring element 144 stable in a single distended position and sealed over the fluid conduit. In this example, the displacement device 130 can draw a vacuum on the fluid channel 112 to pull the haptic element 140 downward into a substantially planar or recessed position, thereby enabling the deformable region 124 to withdraw downward into the retracted setting (e.g., when a user swipes across a palm across the tactile surface 126 to set deformable regions in an alphanumeric keyboard into the retracted setting). Subsequently, the displacement device 130 can release the vacuum on fluid channel 112 such that the haptic element 140 returns to the stable distended position, thereby raising the deformable region 124 into the expanded setting. Thus, when a user applies a force onto the deformable region, the haptic element 140 can resist the force to hold the deformable region 124 in the expanded setting until a threshold force at which the haptic element 140 buckles is achieved, at which point the haptic element 140 (momentarily) snaps downward, the deformable region 124 retracted with it. The haptic element 140 can subsequently return to the stable distended position substantially soon after the user removes the force on the deformable region, and the haptic element 140 can, thus, lift deformable region 124 back into the expanded setting.

In yet another example, the haptic element 140 includes a spring element 144 stable in a single distended position and arranged below the deformable region, the deformable region 124 in the retracted setting (e.g., flush with the peripheral region) with the haptic element 140 in the single distended position. In this example, when the displacement device 130 pumps fluid into the fluid channel, the displacement device 130 transitions into the expanded setting, thereby increasing a distance between an interior surface of the deformable region 124 and the haptic element 140 (still in the distended position). Subsequently, when a user depresses the deformable region, fluid pressure within the fluid circuit can initially (and with limited force) resist depression of the deformable region 124 until the deformable region 124 contacts the haptic element. At this point, further depression of the deformable region 124 can buckle the haptic element, the deformable region 124 thus translating further downward past the peripheral region. When the user removes the depressive force, the haptic element 140 can return to the stable distend position, thus elevating the deformable region 124 (e.g., to a position substantially flush with the peripheral region), and fluid pressure within the fluid circuit can further elevate the deformable region 124 back to the expanded position.

In the foregoing implementation, the spring element 144 can include a metallic or polymeric snapdome or similar structure stable in one or more positions. The spring element 144 can also be sealed around the fluid circuit such that a change in fluid pressure within the fluid circuit (i.e., by displacement of fluid into or out of the fluid channel) affects a position of the haptic element 140—and therefore a position of the deformable region 124 and/or a snap effect upon depression of the deformable region. In this implementation, the haptic element 140 can be disconnected from the deformable region 124 or coupled to the deformable region, such as via an elastic membrane or sinew. The haptic element 140 can also be co-molded into the substrate 110—that is, molded directly into the substrate 110 as a singular structure with the substrate 110. Alternatively, the haptic element 140 can be bonded to the substrate 110, such as with a flexible epoxy or other adhesive that absorbs small deflections of the haptic element 140 as the haptic element 140 transitions between vertical positions (e.g., as a perimeter of the haptic element 140 that includes a snapdome curls when depressed).

In another implementation, the displacement device 130 can manipulate fluid pressure within the fluid channel and the fluid conduit to a first pressure greater than a threshold pressure in response to an input at the deformable region, the spring element configured to buckle from the second distended position to the first distended position in response a fluid pressure within the fluid conduit exceeding the threshold pressure. The displacement device 130 can also manipulate fluid pressure within the fluid channel and the fluid conduit to a second pressure less than the threshold pressure in response to transition of the spring element from the second distended position to the first distended position.

As described above, the dynamic tactile interface 100 can be integrated over a display and/or a touchscreen within a computing device (e.g., a smartphone), and elements of the dynamic tactile interface 100 can therefore be substantially transparent. For example, in the foregoing implementations, the spring element(s) can be of a transparent elastomer (e.g., plastic) material, such as polycarbonate or silicone. In this configuration, the displacement device 130 can further displace transparent fluid between the fluid channel 112 and a reservoir.

In the foregoing implementations, the fluid channel 112 can also fluidly couple to a bladder that expands to accommodate fluid displaced out of the fluid channel 112 when the deformable region 124 is depressed. Alternatively, one or more other deformable regions of the tactile layer 120 can expand to with the increased fluid pressure within the fluid channel 112 as the deformable region 124 is depressed from the expanded setting. Yet alternatively, the displacement device 130 can release fluid from the fluid channel 112—such as into a reservoir—when the deformable region 124 is depressed. However, the haptic element 140 can include any other one or more elements and function in any other way to effect a particular (e.g., non-linear) haptic sensation in response to depression of the deformable region.

However, the haptic element 140 can include any other one or more elements and function in any other way to effect a particular (e.g., non-linear) haptic sensation in response to depression of the deformable region.

### 7. Sensor

The sensor 150 of the dynamic tactile interface 100 is configured to output a signal in response to displacement of the deformable region 124 in the expanded setting toward the substrate no. Generally, the sensor 150 functions to output a signal corresponding to depression of the deformable region.

In one implementation, in which the haptic element 140 includes a magnetic or ferrous element coupled to the deformable region, the sensor 150 includes a Hall effect sensor 150 arranged proximal the deformable region 124 and configured to output a signal corresponding to a change in a magnetic field proximal the deformable region. For example, the sensor 150 can be arranged on, beneath, or within the substrate no under the deformable region. Additionally or alternatively, the sensor 150 can be arranged on, within, or beneath the substrate no adjacent the peripheral region. For example, in a variation of the dynamic tactile interface 100 that includes multiple adjacent deformable regions (e.g., in a keyboard layout), each coupled to a magnetic or ferrous element, the sensor 150 can include multiple Hall effect sensors arranged between deformable regions, such as one Hall effect sensor 150 arranged in the substrate 110 adjacent a peripheral region 122 between multiple (e.g., four) deformable regions. In this example, a processor 170 can collect outputs of the multiple Hall effect sensors at a single instant and compare changes in these outputs to identify a particular depressed deformable corresponding a unique combination of (binary or analog) outputs of the multiple Hall effects sensors. Yet alternatively, the second magnet 142 coupled to the deformable region 124 can be conductive and thus bridge a sensor 150 circuit on or within the substrate no when the deformable region 124 is depressed.

In another implementation, the sensor 150 includes a touch sensor, such as a capacitive or resistive touch panel coupled to or physically coextensive with the substrate no, such as described in U.S. patent application Ser. No. 13/414,589. Alternatively, the sensor 150 can include an optical sensor 150 or an ultrasonic sensor 150 that remotely detects a finger, a stylus, or other motion across or above the tactile layer. The sensor 150 can also detect a touch on the tactile surface 126 that does not deform or that does not fully depress one or more deformable regions. However, the sensor 150 can include any other type of sensor 150 configured to output any other suitable type of signal in response to selection and/or depression of one or more deformable regions.

In one implementation in which the haptic element 140 includes a uni-or bi-stable spring element 144 (e.g., a snapdome), the sensor 150 includes conductive traces that pass through the substrate no adjacent the haptic element 140 such that depression of the deformable region 124 and subsequent buckling of the haptic element 140 (momentarily) closes a circuit across the conductive traces, the sensor 150 thus outputting a signal for a keystroke corresponding to depression of the deformable region. In particular, in this implementation, the spring element 144 (e.g., the snapdome) can complete a circuit when depressed (via the corresponding deformable region) to trigger detection of an input on the tactile layer.

In another implementation, the dynamic tactile interface 100 can include a a pressure sensor fluidly coupled to the control channel; further including a digital memory containing a user preference for a magnitude of a force on the deformable region triggering buckling of the spring element from the second distended position into the first distended position; and further including a processor electrically coupled to the pressure sensor, to the digital memory, and to the second displacement device, the processor controlling the displacement device to manipulate a fluid pressure within the fluid channel based on an output of the pressure sensor and the user preference.

### 8. Backlight Element

One variation of the dynamic tactile interface 100 includes a backlight element configured to transmit light through the deformable region. Generally, the backlight element functions to illuminate a back surface of the tactile layer 120 such that at least some light passes through the deformable region 124 to aid visual identification of the deformable region 124 and/or a command associated with the deformable region.

In one implementation in which the dynamic tactile interface 100 is implemented as keyboard in a peripheral or integrated computing device, substrate 110 defines multiple fluid channels, and the tactile layer 120 defines multiple deformable regions, each arranged over a fluid channel 112 and corresponding to one alphanumeric character (e.g., one of A-Z, 0-9, and various punctuation characters). In one example of this implementation, the tactile layer 120 can be substantially opaque, but each deformable region 124 include a translucent area in the shape of a corresponding alphanumeric character such that, when the backlight element is ON, light passes through the transparent characters to provide visual guidance to commands (i.e., characters) corresponding to each deformable region. In this example, the tactile layer 120 can be generally of an opaque color, such as black or silver, and the translucent characters can be of a lighter color, such as white. Alternatively, the tactile layer 120 can be substantially translucent or transparent, and each deformable region 124 can include an opaque area in the shape of a corresponding alphanumeric character such that, when the backlight element is ON, light passes through the tactile layer 120 except at the transparent characters. In this example, the tactile layer 120 can also include a diffuser layer arranged between the tactile surface 126 and the backlight element to smooth lighting across the tactile layer. Similarly, an area of the peripheral region 122 adjacent a deformable region 124 can include such a translucent or opaque area indicating a command corresponding to the adjacent deformable region 124 such that the backlight element illuminates translucent areas across the tactile layer 120 to aid a user in discerning the deformable regions, such as while the user is typing—on a laptop computer including the dynamic tactile interface 100—in a dimly-lit room.

Alternatively, the substrate 110, tactile layer, haptic element, and/or the fluid can be substantially transparent, and the substrate no can be arranged over a digital display (or touchdisplay), wherein the display renders an image of a character of a keystroke corresponding to the deformable region. For example, the dynamic tactile interface 100 can be integrated into a peripheral keyboard for a computing device, and the display can include an e-ink display that renders a current set of characters corresponding to each of the set of deformable regions defined by the tactile layer. Thus, in this example, a user may customize the keyboard by assigned different characters to all or a subset of the deformable regions, and the display can update rendered characters accordingly. Additionally or alternatively, the keyboard can include store preset keyboard layouts for various languages, dialects, and/or location, etc., and the user can manually—or the keyboard can automatically—select a current keyboard layer from the set, and the display can update rendered characters under each corresponding deformable region 124 accordingly. A processor 170 within the keyboard can similarly update outputs corresponding to the various deformable regions accordingly.

In one example of the foregoing implementation, the dynamic tactile interface 100 includes light source coupled to the substrate no opposite the tactile layer, the light source substantially aligned with the deformable region. In this example, the substrate 110 includes a substantially transparent material and tactile layer 120 includes a substantially opaque material coincident the peripheral region 122 and a portion of the deformable region, a second portion of the deformable region 124 including a substantially translucent material and communicating light from the light source through the tactile layer. The second portion of the deformable region can exhibit an alphanumeric symbol and communicates light from the light source across the tactile layer through the alphanumeric symbol.

### 9. Housing

A variation of the dynamic tactile interface 100 can include a housing supporting the substrate no, the tactile layer, the haptic element, and the displacement device 130 (and the bladder), the housing engaging a computing device and retaining the substrate 110 and the tactile layer 120 over a display of the computing device. The housing can also transiently engage the mobile computing device and transiently retain the substrate 110 over a display of the mobile computing device. Generally, in this variation, the housing functions to transiently couple the dynamic tactile interface 100 over a display (e.g., a touchscreen) of a discrete (mobile) computing device, such as described in U.S. patent application Ser. No. 12/830,430. For example, the dynamic tactile interface 100 can define an aftermarket device that can be installed onto a mobile computing device (e.g., a smartphone, a tablet) to update functionality of the mobile computing device to include transient depiction of physical guides or buttons over a touchscreen of the mobile computing device. In this example, the substrate 110 and tactile layer 120 can be installed over the touchscreen of the mobile computing device, a manually-actuated displacement device 130 can be arranged along a side of the mobile computing device, and the housing can constrain the substrate no and the tactile layer 120 over the touchscreen and can support the displacement device. However, the housing can be of any other form and function in any other way to transiently couple the dynamic tactile interface 100 to a discrete computing device.

The systems and methods of the preceding embodiments can be embodied and/or implemented at least in part as a machine configured to receive a computer-readable medium storing computer-readable instructions. The instructions can be executed by computer-executable components integrated with the application, applet, host, server, network, website, communication service, communication interface, native application, frame, iframe, hardware/firmware/software elements of a user computer or mobile device, or any suitable combination thereof. Other systems and methods of the embodiments can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, though any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention defined in the following claims.

I claim:

1. A dynamic tactile interface comprising:
a tactile layer comprising an attachment surface, a peripheral region, and a deformable region adjacent the peripheral region, the deformable region operable between a retracted setting and an expanded setting, the deformable region in the expanded setting tactilely distinguishable from the peripheral region and the deformable region in the retracted setting;
a substrate coupled to the attachment surface at the peripheral region and defining a fluid conduit and a fluid channel fluidly coupled to the fluid conduit, the fluid conduit adjacent the deformable region;
a displacement device fluidly coupled to the fluid channel and configured to displace fluid into the fluid conduit to transition the deformable region from the retracted setting to the expanded setting and to displace fluid out of the fluid conduit in response to an input on the deformable region in the expanded setting to transition the deformable region from the expanded setting to the retracted setting;
a first magnet coupled to the substrate proximal the deformable region;
a second magnet coupled to the tactile layer at the deformable region and magnetically coupled to the first magnet, the first magnet and the second magnet cooperating to yield a nonlinear displacement of the deformable region in the expanded setting toward the substrate in response to a force applied to the tactile surface at the deformable region, the first magnet contacting the second magnet in the retracted setting and offset from the second magnet by an attraction distance in the expanded setting; and
a sensor outputting a signal in response to displacement of the deformable region toward the substrate.

2. The dynamic tactile interface of claim 1, wherein, in the expanded setting, the first magnetic and the second magnet exhibit an attractive force less than a force to displace fluid from the fluid channel in the expanded setting.

3. The dynamic tactile interface of claim 1, wherein the deformable region is substantially flush with the peripheral region in the retracted setting and the deformable region is offset above the peripheral region in the expanded setting.

4. The dynamic tactile interface of claim 1, wherein the tactile layer further comprises a second deformable region adjacent the deformable region and the peripheral region, the second deformable region operable between the expanded setting and the retracted setting; wherein the substrate defines a second fluid channel and a second fluid conduit fluidly coupled to the second fluid channel and adjacent the second deformable region; wherein the displacement device fluidly couples to the second fluid channel and displaces fluid into the second fluid conduit to transition the second deformable region from the retracted setting to the expanded setting, the deformable region at a first height above the peripheral region in the expanded setting and the second deformable region at a second height above the peripheral region in the expanded setting, the second height greater than the first height; wherein the first magnet is proximal the second deformable region; further comprising a third magnet coupled to the second deformable region magnetically attracted to the first magnet, the third magnet exhibiting greater magnetic strength than the second magnet.

5. The dynamic tactile interface of claim 1, further comprising a platen coupled to the attachment surface at the deformable region and movably arranged in the fluid conduit, the platen supporting the deformable region to define a planar surface across the deformable region in the expanded setting and to define a surface flush with the peripheral region in the retracted setting.

6. The dynamic tactile interface of claim 1, further comprising a light source coupled to the substrate opposite the tactile layer, the light source substantially aligned with the deformable region; wherein the substrate comprises a substantially transparent material; and wherein the tactile layer comprises a substantially opaque material coincident the peripheral region and a portion of the deformable region, a second portion of the deformable region comprising a substantially translucent material and communicating light from the light source through the tactile layer.

7. The dynamic tactile interface of claim 6, wherein the second portion of the deformable region exhibits an alphanumeric symbol and communicates light from the light source across the tactile layer through the alphanumeric symbol.

8. The dynamic tactile interface of claim 1, further comprising a compressible member coupled to the substrate and arranged in the fluid conduit, the first magnet coupled to a surface of the compressible member, the compressible member compressed away from the tactile layer in the retracted setting and expanded toward the tactile layer in the expanded setting, the compressible member resisting transition of the deformable region from the expanded setting to the retracted setting.

9. The dynamic tactile interface of claim 8, wherein the compressible member comprises a flexure, the flexure deflecting toward the deformable region in the expanded setting and deflecting toward a base of the substrate in the retracted setting.

10. The dynamic tactile interface of claim 1, wherein the second magnet cooperates with the first magnet to draw the deformable region in the expanded setting toward the substrate according to a force increasing with a decrease in distance between the first magnet and the second magnet, the distance between the first magnet and the second magnet directly proportional to displacement of the deformable region.

11. A dynamic tactile interface comprising:
a tactile layer comprising a peripheral region and a deformable region adjacent the peripheral region, the deformable region operable between a retracted setting and an expanded setting, the deformable region offset above the peripheral region in the expanded setting;
a substrate coupled to the peripheral region and defining a fluid conduit and a fluid channel fluidly coupled to the fluid conduit, the fluid conduit adjacent the deformable region;
a displacement device fluidly coupled to the fluid channel and configured to displace fluid into the fluid channel to transition the deformable region from the retracted setting to the expanded setting ;
a first magnet coupled to the substrate proximal the deformable region and adjacent the fluid conduit; and
a second magnet coupled to the tactile layer at the deformable region and magnetically coupled to the first magnet, the first magnet and the second magnet cooperating to draw the deformable region in the expanded setting toward the substrate in response to an input on the deformable region, the deformable region displacing fluid into the fluid conduit and toward the fluid channel in response to displacement toward the substrate.

12. The dynamic tactile interface of claim 11, wherein the displacement device displaces fluid out of the fluid channel in response to an input to the deformable region to cooperate with the first magnet and the second magnet to transition the deformable region from the expanded setting to the retracted setting.

13. The dynamic tactile interface of claim 11, further comprising a sensor outputting a signal corresponding to displacement of the deformable region toward the substrate.

14. The dynamic tactile interface of claim 11, wherein the tactile layer defines the deformable region offset below the peripheral region in the retracted setting and offset above the peripheral region in the expanded setting; wherein the first magnet and the second magnet further cooperate to retain the deformable region in the retracted setting in response to removal of an input from the deformable region; and wherein the displacement device displaces fluid into the fluid channel to overcome an attractive force between the first magnet and the second magnet to transition the deformable region from the retracted setting to the expanded setting.

15. The dynamic tactile interface of claim 11, further comprising a housing configured to transiently engage an exterior of a computing device to transiently retain the substrate over a display of the computing device, the substrate supporting the displacement device.

16. The dynamic tactile interface of claim 11, wherein the deformable region defines an exterior surface flush with an exterior surface of the peripheral region in the retracted setting.

17. The dynamic tactile interface of claim 11, further comprising a pivot coupled to the substrate and arranged in the fluid conduit; wherein the pivot supports the first magnetic with a first pole of the first magnet adjacent the second magnet to attract the second magnet in a first configuration and supports the first magnetic with a second pole of the magnet adjacent the second magnet to repel the second magnet in a second configuration, the pivot rotating between the first configuration and the second configuration in response to a detected input on the tactile layer.

18. The dynamic tactile interface of claim 17 wherein the pivot comprises an electromechanical pivot rotating into the first configuration in response to a first detected input at the deformable region and rotating into the second configuration in response to a second detected input at the deformable region.

19. The dynamic tactile interface of claim 11, further comprising a bladder fluidly coupled to the fluid channel and adjacent a back surface of the substrate opposite the tactile layer; wherein the displacement device compresses the bladder to displace fluid from the bladder into the fluid channel to transition the deformable region from the retracted setting to the expanded setting.

20. The dynamic tactile interface of claim 11, wherein the second magnet substantially contacts the first magnet in the retracted setting.
